(19) United States
(12) Patent Application Publication
(10) Pub. No.: US 2010/0130091 A1
(43) Pub. Date: May 27, 2010

(54) METHOD AND APPARATUS FOR SEALING A PHOTONIC ASSEMBLY

(76) Inventor: Brian Paul Strines, Painted Post, NY (US)

Correspondence Address: CORNING INCORPORATED, SP-TI-3-1, CORNING, NY, 14831, US

(21) Appl. No.: 12/276,771

(22) Filed: Nov. 24, 2008

(51) Int. Cl. H01J 9/26; H01J 9/38

(52) U.S. Cl. 445/25; 445/70

(57) ABSTRACT

A method of sealing a photonic assembly comprising several substrate plates and a sealing material disposed therebetween using a frame that may be positioned over and about a perimeter of the assembly. The frame and the assembly form a free space region between the frame and the assembly. A vacuum is applied to the free space region, for example through a passage formed in the frame, thereby causing a force to be applied against the frame and the assembly, via ambient atmospheric pressure, that facilitates the formation of a seal between the substrates when the sealing material is cured. An apparatus for performing the method is also disclosed.

### BACKGROUND OF THE INVENTION

1. Field of the Invention

This invention is directed to a method of sealing a photonic assembly, and in particular a method and apparatus for applying a force on the photonic assembly to facilitate sealing the assembly to form a photonic device. The device may be, for example, an organic light emitting diode device comprising sealed glass substrate plates.

2. Technical Background

Photonic devices may be comprised of several sealed glass substrates including a photonic material disposed between the substrates. By photonic material what is meant is a material that either produces light in response to an applied electric current and/or voltage or produces an electric current in response to exposure to light. For example, organic light emitting devices typically comprise two glass substrates and an organic light emitting material positioned between the substrates. The assembly is sealed with a sealing material that surrounds the organic electroluminescent (EL) material and joins the substrates, thus sealing out contaminants that may degrade the organic EL material. The sealing material may be for example a glass-based frit, or the sealing material may be an adhesive, such as an organic adhesive. The sealing material is disposed about a perimeter of the device and, in conjunction with the glass plates, form an encapsulating glass package for the photonic material (e.g. EL material). The photonic device may be, for example, a display device useful for cell phones, computers, personal data assistants (PDAs), or a lighting panel. In other applications, the photonic device may comprise a photovoltaic (PV) device, such as a PV panel, for converting light into electrical energy.

In the case of organic light emitting diode devices in particular, care must be taken to ensure that the seal between the substrate plates is sufficiently hermetic to protect the organic electroluminescent material for a suitable length of time based on the particular application and need. This is true because the organic materials used in the manufacture of organic light emitting diode devices are sensitive to oxygen and moisture, and can quickly degrade when exposed to the atmosphere. Proper seals are often formed by applying a force against at least one of the substrates to ensure appropriate contact between the substrate plates and the sealing material using small magnets that are placed on top of the assembly when a steel plate is used to support the assembly. However, such approaches may result in uneven force around the perimeter of the seal, and debris from handing of the magnets may contaminate the seal. Thus, a sealing method that does not contribute contaminates to the resulting photonic device, and which are capable of applying a uniform force around the perimeter of the assembly would be beneficial.

### SUMMARY

In one embodiment, a method of sealing a photonic assembly is disclosed comprising positioning a frame over and about a perimeter of a photonic assembly comprising a first substrate plate, a second substrate plate and a first sealing material disposed between the first and second substrate plates, a first gasket being positioned between the frame and the photonic assembly and a second gasket being positioned between the frame and a support plate supporting the photonic assembly, reducing a pressure in a free space region between the frame and the photonic assembly below an ambient pressure external to the frame, thereby causing a force to be exerted on the frame; curing the first sealing material to form a first seal between the first and second substrate plates; and removing the frame from the sealed assembly.

In another embodiment, an apparatus for sealing a photonic assembly is described comprising a frame formed as a closed loop encircling an open area, a first gasket positioned proximate an outside perimeter of the frame, a second gasket positioned proximate an inside perimeter of the frame and wherein the frame is adapted so that the first and second gaskets contact a support plate and the photonic assembly, respectively, when the frame is positioned over and about the photonic assembly.

The invention will be understood more easily and other objects, characteristics, details and advantages thereof will become more clearly apparent in the course of the following explanatory description, which is given, without in any way implying a limitation, with reference to the attached Figures. It is intended that all such additional systems, methods features and advantages be included within this description, be within the scope of the present invention, and be protected by the accompanying claims.

### BRIEF DESCRIPTION OF THE DRAWINGS

FIG. 1 is a cross sectional view of an exemplary photonic assembly;

FIG. 2 is a perspective view of an apparatus for sealing a photonic assembly according to an embodiment of the present invention;

FIG. 3 is a cross sectional side view of a portion of the apparatus of FIG. 2;

FIG. 4 is a top down view of the apparatus of FIG. 2 shown holding down a photonic assembly comprising a plurality of photonic devices.

### DETAILED DESCRIPTION

In the following detailed description, for purposes of explanation and not limitation, example embodiments disclosing specific details are set forth to provide a thorough understanding of the present invention. However, it will be apparent to one having ordinary skill in the art, having had the benefit of the present disclosure, that the present invention may be practiced in other embodiments that depart from the specific details disclosed herein. Moreover, descriptions of well-known devices, methods and materials may be omitted so as not to obscure the description of the present invention. Finally, wherever applicable, like reference numerals refer to like elements.

As used herein, the singular forms “a,” “an” and “the” include plural referents unless the context clearly dictates otherwise. Thus, for example, reference to a “component” includes aspects having two or more such components, unless the context clearly indicates otherwise.

Optional” or “optionally” means that the subsequently described event or circumstance can or cannot occur, and that the description includes instances where the event or circumstance occurs and instances where it does not. For example, the phrase “optionally substituted component” means that the component can or can not be substituted and that the description includes both unsubstituted and substituted aspects of the invention.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, a “frit” or “frit composition,” unless specifically stated to the contrary, refers to mixture of base and absorbing components, and optionally a filler material such as an inert filler for adjusting a coefficient of thermal expansion of the frit. The term “frit” or “frit composition” can refer to any physical form of a frit, including a powder, a paste, an extruded bead, and can also refer to an attached or unattached frit deposited on a substrate.

As used herein, a “loop”, in reference to the frit or adhesive location, refers to a line of a material that forms a bounded region. The loop line can, for example, intersect with one or more portions of the line forming the bounded region (a closed loop), or can be a continuous line having no beginning or end and also forming a bounded region. A loop can have curved portions, straight portions, and/or corners, and no specific geometry is intended.

As used herein, a “perimeter” can refer to either the outer edge of a device or a location at or near the outer edge of a device. For example, a material positioned around the perimeter of a substrate can mean that the material is positioned either on the edge of the substrate or on a surface of the substrate at or near the edge.

As used herein, a photonic assembly is any assembly having components that utilize photons in the functioning of a device formed from the assembly. For example, a photonic assembly may be used to convert electrical energy into light, or light into electrical energy. Photonic assemblies may, for example, be included in electroluminescent displays, electroluminescent lighting panels, or photovoltaic (PV) devices for converting light into electrical energy (e.g. solar cells). For the purposes of discussion and not limitation, the following disclosure will be presented in the context of a photonic assembly used to fabricate an electroluminescent device such as an organic light emitting diode (OLED) display device suitable for use as a television or computer display, with the understanding that the invention may be similarly used to seal other photonic assemblies.

An exemplary photonic assembly 10, illustrated in FIG. 1, comprises first substrate 12, second substrate 14, and sealing material 16 disposed between the two substrates. Sealing material 16 is preferably formed as a closed loop positioned inside of the perimeter of the first and second substrates. Photonic assembly 10 further comprises a photonic material 18 positioned between the two substrates within the area defined by the encircling sealing material 16. Photonic material 18 may be, for example, an organic light emitting material. When sealing material 16 is appropriately conditioned or processed, a seal is formed between the first and second substrates 12, 14 that connects the substrates and forms an encapsulating package that protects the photonic material disposed therein. That is, the photonic material is protected between the two substrate plates 12, 14 and the encircling sealing material 16. Photonic assembly 10 may further comprise electrical leads, anodes, cathodes, or other electrical connection members (not shown) that may pass through sealing material 16 as appropriate to the particular device.

As used herein, processing or conditioning of the sealing material to form the seal will be referred to as “curing” of the sealing material, where curing shall be understood to mean heating, irradiating, or any other method of applying energy to the sealing material that results in the formation of a seal that joins the first and second substrates. Thus, for example, the sealing material may be a ultraviolet (UV) or infrared (IR) light curable adhesive, such as a polymer resin that undergoes cross linking when exposed to the irradiating light, a heat curable resin, or the curing may comprise irradiating a glass-based frit with an infrared light sufficient to melt the glass-based frit that, upon cooling, forms a seal between the substrates.

First and second substrates 12, 14 may be glass, plastic or any other material suitable as a substrate for a photonic device. At least one of the substrates should be transparent, preferably at visible wavelengths, for transmitting or receiving light through the substrate. In some embodiments both substrates may be transparent. The composition of the substrates may dictate the choice of sealing material. For example, an adhesive or a glass based frit may be used to join glass substrates. On the other hand, if substrates 12, 14 are plastic, a glass based frit may be potentially inappropriate if a curing temperature that exceeds a temperature that can be tolerated by the plastic is involved. In some embodiments, both a glass based frit and an adhesive may be used to form a plurality of assembly seals. Such seals may be formed, for example, utilizing an inner, glass frit-based seal formed from a glass frit, and an adhesive seal (e.g. an epoxy seal) formed outside of (e.g. concentric with) the inner frit seal. Dual seals combine a hermetic inner glass seal with a resilient outer seal for increased mechanical integrity.

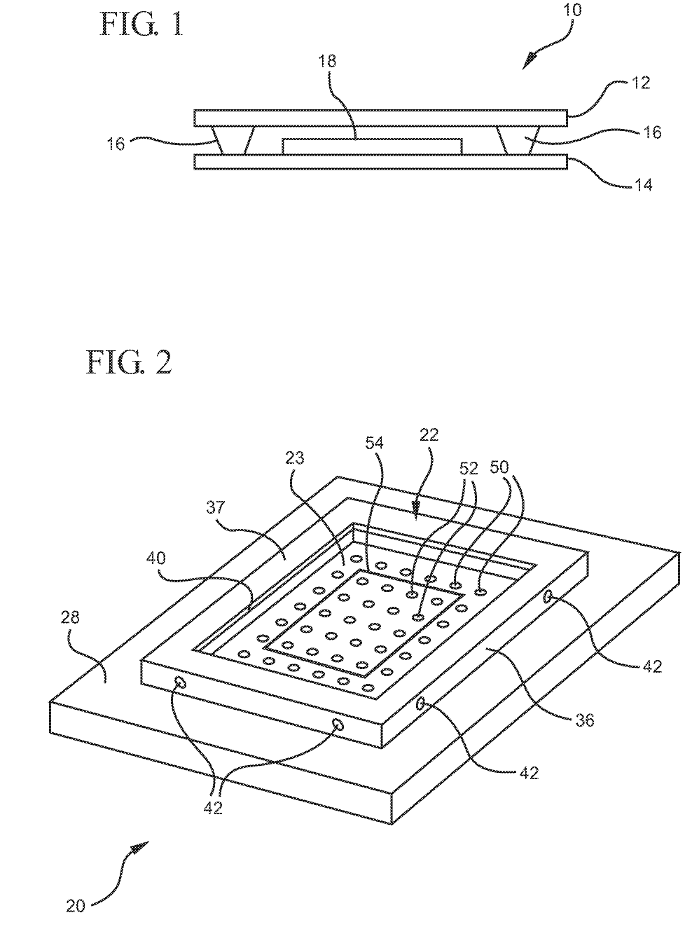

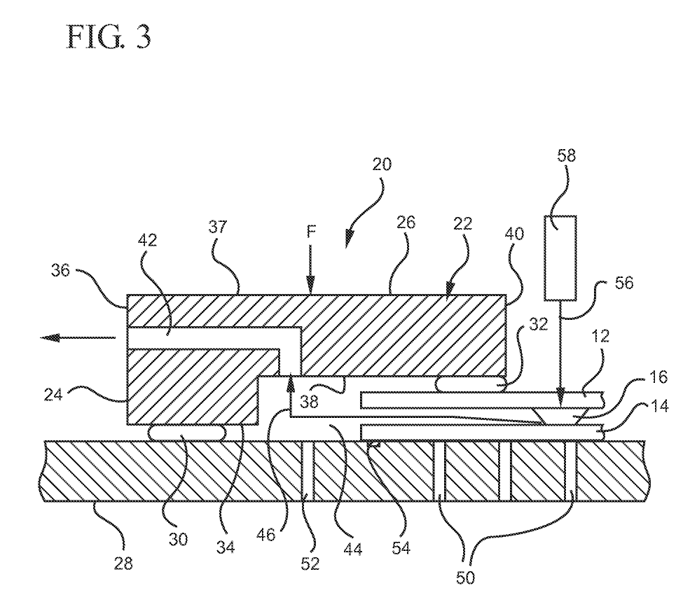

An apparatus 20 for sealing a photonic assembly in accordance with an embodiment of the invention is shown in FIG. 2. Apparatus 20 comprises frame 22 in the form of a closed loop encircling or enclosing an open area 23. For example, the overall shape of frame 22 may be a rectangle. Frame 22 is preferably formed from a light weight metal such as aluminum, although other materials may be used (e.g. stainless steel). It is preferable to use a corrosion resistant material to prevent buildup of potential contaminants on the surface of the frame. As best shown in FIG. 3, frame 22 includes a generally vertical leg portion 24 and a generally horizontal arm portion 26, giving the frame an “L” shaped cross section. In this context, the terms “vertical” and “horizontal” are terms relative to the orientation of the frame, and a reference plane. That is, when frame 22 is placed over and about assembly 10, leg 24 is generally vertical relative to a plane of the substrates of assembly 10. The term “generally” in the present context is intended to imply that the leg portion and arm portions may have other angular orientations relative to each other, and need not be precisely orthogonal, but that frame 20 includes a leg portion that is positionable about an outside perimeter of assembly 10, while at the same time an arm portion extends over a portion of the assembly 10 perimeter.

Apparatus 20 may further comprise support plate 28 for supporting frame 22 and photonic assembly 10. Support plate 28 is preferably planar, and can be manufactured from a variety of materials, including but not limited to a ceramic, aluminum or stainless steel. The plane of support plate 28 is parallel to the plane of at least one of the major surfaces of substrates 12 or 14, and preferably parallel to the major surfaces of both substrates.

Frame 22 may further comprise first and second gaskets 30, 32 (FIG. 3) formed from a compliant material that preferably does not emit volatile constituents such as plasticizers, particularly if heated, and does not leave a stain or residue on the assembly substrates or support plate. As illustrated in the cross section of FIG. 3, first gasket 30 is positioned on the underside surface 34 of leg portion 24 proximate exterior perimeter or surface 36, while second gasket 32 is positioned on underside surface 38 of arm portion 26 proximate interior perimeter (surface) 40. Alternatively, first gasket 30 may be included as a portion of support plate 28. For example, support plate 28 may comprise a groove into which gasket 30 may be held. Alternatively, gasket 30 may be loosely positioned between the support plate and the frame.

Frame 22 may further define one or more passages 42 to which a vacuum may be applied. As shown in FIG. 3, frame 22 is supported by support plate 28 and positioned around and over assembly 10 such that first gasket 30 is in contact with support plate 28 and second gasket 32 is in contact with first substrate 12 (or second substrate 14, recognizing that assembly 20 may be flipped and placed on support plate in a reversed position). The resulting free space region 44 is thus formed between frame 22, assembly 10 and support plate 28. Accordingly, passages 42 may extend from an outside surface of frame 22 (e.g. surface 36 and/or surface 37) to a surface of frame 22 within free space region 44 (e.g. surface 38) such that when a vacuum is applied to passage 42 the atmosphere within free space region 44 is removed and the pressure in the free space region is reduced. As an example, FIG. 3 illustrates passage 42 extending from exterior surface 36 to interior surface 38. Passage 42 could just as easily be a straight passage through arm portion 26 from surface 37 to surface 38. Preferably, the atmosphere disposed between first and second substrates 12, 14 is also removed, as indicated by arrow 46, thereby reducing the pressure of the assembly interior atmosphere.

The reduced pressure in free space volume 44 results in a pressure differential between free space volume 44 and the ambient atmosphere surrounding apparatus 20, that in turn results in a force F being applied to the top surface 37 of frame 22. Force F a) causes frame 22 to be forced downward toward support plate 28 and a temporary seal to form between first and second gaskets 30, 32 and support plate 28 and assembly 10, respectively, and b) results in increased contact between substrates 12, 14 and sealing material 16. The increased contact between substrates 12, 14 and sealing material 16 facilitates an improved seal between the substrates when sealing material 16 is cured. In some embodiments, at least a portion of the atmosphere contained between the substrate plates and within a perimeter of the sealing material, e.g. surrounding photonic material 18, may also be removed (as indicated by arrow 46) in response to the vacuum applied to passage 42 so that a differential pressure is also produced across first substrate plate 12 (or substrate 14), and thus additional force may be applied against first sealing material 16 by the ambient pressure external to substrate plate 12 (or substrate 14).

In some embodiments, a vacuum may be applied through passages 52 in support plate 28 that open into free space region 44. Passages 52 may be in addition to passages 42. That is, both passages 42 and passages 52 may be used, but the use of both is not necessary. In other embodiments, additional passages 50 may be formed in support plate 28 that are positioned underneath assembly 10 such that when a vacuum is applied to the additional passages 50, at least plate 14 (or plate 12) may be held firmly against support plate 28. In the event that plate 28 includes passages 50, a third gasket 54 positioned between bottom substrate plate 14 and support plate 28 may optionally be used to seal free space region 44 from passages 50. The vacuum applied in each of the foregoing embodiments may be applied using conventional methods, such as a vacuum pump and other associated hardware (e.g. an accumulator bottle for reducing surging from the pump, valves, piping, etc.). The vacuum applied to passages 42, and/or 50, and/or 52 may be independently controlled via one or more control valves (not shown) to control the differential pressure and therefore the force applied to assembly 10 by frame 22. Preferably, the vacuum (reduced pressure) is controlled within 50 mbar or less.

Once frame 22 is positioned over and biased against assembly 10 and support plate 18 via a pressure differential across frame 22, sealing material 16 is cured by a method appropriate to the sealing material. For example, FIG. 3 illustrates a glass based frit as the sealing material. The glass based frit is cured by irradiating the frit through substrate 12 with a laser beam 56 produced by laser 58. Laser beam 56 is traversed over the length of seal material 16 until the seal material is properly cured. In this case, the laser beam heats the frit until the frit softens and forms a seal between substrates 12, 14. A fuller description of an exemplary method for laser sealing a glass package can be found in U.S. Pat. No. 6,998,776, the contents of which are incorporated herein in their entirety by reference.

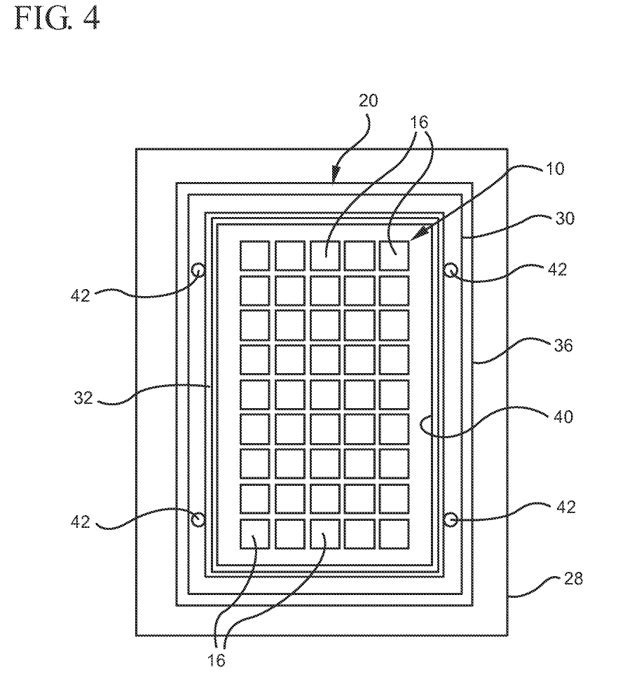

FIG. 4 depicts a top-down view of apparatus 20 positioned over and about assembly 10, wherein assembly 10 comprises a plurality of closed loops of sealing material 16 positioned between substrates 12, 14. According to the embodiment of FIG. 4, passages 42 extending through frame 22 to free space region 44 are disposed in a top surface of the frame. Each loop of sealing material 16 represents a future photonic device: after sealing material 16 is cured, each subsequently sealed device is separated from the parent composite structure between the individual device seals.

Use of the present invention may:
reduce apparatus and assembly set up times compared to the use of discrete force applicators, such as magnets.
reduce the risk of damaging a lens associated with an irradiating light source with smoke when irradiating the sealing material if a rubberized magnet is inadvertently burned with, for example, a laser used in the sealing process.
apply a uniform force on the entire assembly, and minimize the risk that a substrate plate is not driven into the photonic material, thus physically damaging the EL material and rendering the device unusable. A tunable vacuum level can be applied with appropriate valving and metering control to provide an evenly distributed and proper level of contact between the sealing material and the substrates while avoiding substrate-to-photonic material contact.
secure the substrate plate(s) in place, thus preserving proper alignment of the substrates and/or the sealing material.
eliminate the need for large vacuum chambers.
enable fast vacuum cycle times compared to the time required to cycle a large volume vacuum chamber.
eliminate obstructions between, for example, a laser and target device because the contact force is already applied.

It should be emphasized that the above-described embodiments of the present invention, particularly any “preferred” embodiments, are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A method of sealing a photonic assembly comprising:
positioning a frame over and about a perimeter of a photonic assembly comprising a first substrate plate, a second substrate plate and a sealing material disposed between the first and second substrate plates, a first gasket being positioned between the frame and the photonic assembly and a second gasket being positioned between the frame and a support plate supporting the photonic assembly;
reducing a pressure in a free space region between the frame and the photonic assembly below an ambient pressure external to the frame, thereby causing a force to be exerted on the frame;
curing the sealing material to form a seal between the first and second substrate plates; and
removing the frame from the sealed assembly.

2. The method according to claim 1, wherein the first and second substrate plates are comprised of glass.

3. The method according to claim 1, wherein the sealing material is a glass based frit.

4. The method according to claim 2, wherein the curing comprises irradiating the sealing material with an infrared light.

5. The method according to claim 4, wherein the infrared light is produced by a laser.

6. The method according to claim 1, wherein the pressure in the free space region is reduced by applying a vacuum through a passage defined by the frame.

7. The method according to claim 1, wherein the pressure in the free space region is reduced by applying a vacuum through a passage defined by the support plate.

8. The method according to claim 1, wherein the sealing material is formed as a closed loop between the first and second substrate plates.

9. The method according to claim 1, further comprising a photonic material disposed between the first and second glass substrate plates.

10. The method according to claim 9, wherein the photonic assembly comprises an organic material.

11. The method according to claim 10, wherein the photonic assembly is an electroluminescent assembly or a photovoltaic assembly.

12. The method according to claim 1, wherein the support plate supporting the assembly is adjacent either the first or second substrate, and further comprising reducing a pressure beneath the first or second substrate through a second passage defined by the support plate.

13. The method according to claim 12, further comprising positioning the assembly over a third gasket disposed between the assembly and the support plate.

14. An apparatus for sealing a photonic assembly comprising:
a frame formed as a closed loop encircling an open area, the frame comprising:
a first gasket positioned proximate an outside perimeter of the frame;
a second gasket positioned proximate an inside perimeter of the frame; and
wherein the frame is adapted so that the first and second gaskets contact a support plate and the photonic assembly, respectively, when the frame is positioned over and about the photonic assembly.

15. The apparatus according to claim 14, wherein the frame further comprises a passage for applying a vacuum to a free space region formed between the frame and the photonic assembly when the frame is positioned over and about an outside perimeter of the photonic assembly.

16. The apparatus according to claim 14, wherein the support plate defines a passage for applying a vacuum to a free space region formed between the frame and the photonic assembly when the frame is positioned over and about a perimeter of the photonic assembly.

17. The apparatus according to claim 14, wherein the support plate defines a passage for applying a vacuum and securing the photonic assembly to the support plate.

18. The apparatus according to claim 14, wherein the photonic assembly comprises a plurality of photonic devices.
